(19) United States
(12) Patent Application Publication
(10) Pub. No.: US 2024/0276334 A1
(43) Pub. Date: Aug. 15, 2024

(54) MOBILITY MANAGEMENT FOR WIRELESS LOCAL AREA NETWORK

(71) Applicant: Samsung Electronics Co., Ltd., Suwon-si (KR)

(72) Inventors: Peshal Nayak, Plano, TX (US); Boon Loong Ng, Plano, TX (US); Rubayet Shafin, Allen, TX (US); Vishnu Vardhan Ratnam, Plano, TX (US); Yue Qi, Plano, TX (US); Elliot Jen, Taipei City (TW)

(21) Appl. No.: 18/419,475

(22) Filed: Jan. 22, 2024

Related U.S. Application Data
(60) Provisional application No. 63/445,961, filed on Feb. 15, 2023.
(60) Provisional application No. 63/459,128, filed on Apr. 13, 2023.

(51) Int. Cl. H04W 36/28; H04W 36/00; H04W 36/08

(52) U.S. Cl. CPC H04W 36/28; H04W 36/00835; H04W 36/08

(57) ABSTRACT

An access point (AP) device comprises a communication interface; and a processor operably coupled to the communication interface. The processor configured to cause establishing a logical AP MLD, wherein a plurality of APs including an AP affiliated with a first physical AP MLD and an AP affiliated with a second physical AP MLD are affiliated with the logical AP MLD.

### CROSS REFERENCE TO RELATED APPLICATION

This application claims benefit of U.S. Provisional Application No. 63/445,961 filed on Feb. 15, 2023, and U.S. Provisional Application No. 63/459,128 filed on Apr. 13, 2023, in the United States Patent and Trademark Office, the entire contents of which are hereby incorporated by reference.

### TECHNICAL FIELD

The disclosure relates to mobility management for wireless local area networks.

### BACKGROUND

As a station (STA) moves around, the signal strength of the STA to its connected access point (AP) may fluctuate. If substantial signal degradation occurs due to user movement, a handover may become necessary. The handover process involves the STA transitioning from its current AP to a new one.

For legacy devices without any mobility support, the handover procedure may involve the following steps: a detection phase, a search phase, an IEEE 802.11 authentication, an IEEE 802.11 association phase, an IEEE 802.1X authentication phase, and an IEEE 802.11 resource reservation phase.

During the detection phase, the STA may determine the need for the handover. The specific method for detecting the need for handover may be subject to vendor implementation. In some embodiments, the STA may choose to trigger handover when the signal strength to the currently associated AP falls below a predefined threshold.

During the search phase followed by a search phase, the STA may search for new APs to associate with. The search phase involves scanning different channels to identify APs in the vicinity. This can be done either passively or actively. For example, the STA may passively search for APs by listening to beacons on a particular channel. The STA may actively search for APs using the probe request and response procedure.

After the search phase is complete, the IEEE 802.11 authentication (open system/shared key based) may be performed.

Once the STA is authenticated, the STA performs IEEE 802.11 association according to and IEEE 802.1X authentication.

The IEEE 802.1X authentication which is introduced in IEEE 802.1i amendment comprises an EAP authentication between the STA and a AAA server with the assistance of the AP.

The subsequent step may be the IEEE 802.11 resource reservation. This phase may involve the STA configuring various resources at the new AP such as QoS reservation and Block Acknowledgment (BA) setup with the newly associated AP.

The handover in a break-before-make manner may result in a disruption in the connection. This can notably impact user experience especially with multimedia services which may suffer from session disruptions due to the high delay encountered during handover procedure.

Various procedures have been introduced in several standards to remove or reduce the delay encountered in several steps of the handover procedure. In 2008, IEEE 802.11r introduced fast transition roaming eliminating the need for the IEEE 802.11 authentication step during the handover. In 2011, IEEE 802.11k introduced assisted roaming which reduces the search phase by allowing the STA to request the AP to send channel information of candidate neighbor APs. In 2011, IEEE 802.11v also introduced network assisted roaming to assist the search phase. The IEEE 802.11be standard extended the fast BSS transition procedure to cover the case of Multi-Link Operation (MLO) to reduce the delays encountered due to IEEE 802.11 resource reservation. However, the STA still needs to perform the association and authentication phases which can take several milliseconds.

The description set forth in the background section should not be assumed to be prior art merely because it is set forth in the background section. The background section may describe aspects or embodiments of the present disclosure.

### SUMMARY

Embodiments propose some methods to enable a support handover with minimal delays and enable wireless devices to achieve low latencies in many mobility related scenarios. Embodiments relate to improvements to the latency in the handover.

One embodiment of the present disclosure may provide an access point (AP) device comprising a communication interface and a processor operably coupled to the communication interface.

In some embodiments, the processor may be configured to cause establishing a logical AP multi-link device (MLD) with which a plurality of APs including one or more APs affiliated with a first physical AP MLD and one or more APs affiliated with a second physical AP MLD are affiliated.

In some embodiments, the processor may be configured to further cause transferring a functionality of the logical AP MLD to a target AP MLD in response to a handover of a non-AP station (STA) from a serving AP MLD to the target AP MLD.

In some embodiments, the AP device may further comprise a plurality of APs affiliated with the AP device, and at least one AP may be affiliated with the logical AP MLD.

In some embodiments, the processor may be configured to further cause tearing down a functionality of the logical AP MLD in response to a handover of a non-AP station (STA) from a serving AP MLD to the target AP MLD.

In some embodiments, the processor may be configured to further cause transmitting, by an AP affiliated with the logical AP MLD, a frame including information for discovering the logical AP MLD.

In some embodiments, the processor may be configured to further cause receiving, by an AP affiliated with the logical AP MLD, from an STA affiliated with a non-AP MLD, a request frame requesting information for discovering the logical AP MLD,

In some embodiments, the frame including information for discovering the logical AP MLD may be transmitted to the non-AP MLD in response to the request frame.

In some embodiments, the processor may be configured to further cause transmitting, by an AP affiliated with the logical AP MLD, a beacon frame including information for the logical AP MLD.

In some embodiments, the processor may be configured to further cause transmitting, by an AP affiliated with the logical AP MLD, a frame including a link identifier and an identifier of the logical AP MLD.

In some embodiments, the identifier of the logical AP MLD coupled with the link identifier may indicate a link of a plurality of links in the logical AP MLD.

In some embodiments, the processor may be configured to further cause receiving, from a station (STA) affiliated with a non-AP MLD, by an AP affiliated with the logical AP MLD, an association request frame to request an association with the logical AP MLD, and transmitting, by an AP affiliated with the logical AP MLD, an association response frame to the STA affiliated with the non-AP MLD in response to the association request frame.

In some embodiments, the association response frame may include an association identifier and an identifier of the AP device, and the identifier of the AP device coupled with the association identifier may indicate a value assigned to the non-AP MLD by the logical AP MLD for association.

In some embodiments, the processor may be configured to further cause receiving, by an AP affiliated with the logical AP MLD, from a station (STA) affiliated with a non-AP MLD, a handover request frame to request a handover from a serving AP MLD to a target AP MLD.

In some embodiments, the processor may be configured to further cause transmitting a context transfer frame from a serving AP to the target AP.

In some embodiments, the context transfer frame may include at least one of a type of context to be transferred, or a transfer time at which context transfer occurs.

One embodiment of the present disclosure may provide a non-AP MLD comprising a plurality of non-AP stations (STAs) affiliated with the non-AP MLD, and a processor operably coupled to the communication interface.

In some embodiments, the processor may be configured to cause associating with a logical AP MLD with which a plurality of APs including one or more APs affiliated with a first physical AP MLD and one or more APs affiliated with a second physical AP MLD are affiliated.

In some embodiments, the processor may be configured to further cause receiving, by an STA affiliated with the non-AP MLD, a frame including information for discovering the logical AP MLD.

In some embodiments, the information for discovering the logical AP MLD may include at least one of an information item indicating whether the plurality of APs are able to be associated with the logical AP MLD, an information item indicating one or more of the plurality of APs are able to establish the logical AP MLD, an identifier of the logical AP MLD, an information item indicating whether the logical AP MLD has been established, identifiers of APs affiliated with the logical AP MLD, identifiers of AP MLDs having APs affiliated with the logical AP MLD, a duration for which the logical AP MLD is hosted, information describing capabilities of the logical AP MLD, information describing constraints of the logical AP MLD, information describing configuration of the logical AP MLD, or information describing traffic status of the logical AP MLD.

In some embodiments, the processor may be configured to further cause transmitting, by an STA affiliated with the non-AP MLD, to an AP affiliated with the logical AP MLD, a request frame requesting information for discovering the logical AP MLD.

In some embodiments, the frame including information for discovering the logical AP MLD may be received in response to the request frame.

In some embodiments, the processor may be configured to further cause receiving, by an STA affiliated with the non-AP MLD, a beacon frame including information for the logical AP MLD.

In some embodiments, the processor may be configured to further cause transmitting, by an STA affiliated with the non-AP MLD, to an AP affiliated with the logical AP MLD, an association request frame to request an association with the logical AP MLD, and receiving, by an STA affiliated with the non-AP MLD, an association response frame to the non-AP MLD in response to the association request frame.

In some embodiments, the processor may be configured to further cause transmitting, by an STA affiliated with the non-AP MLD, to an AP affiliated with the logical AP MLD, a handover request frame to request a handover from a serving AP MLD to a target AP MLD.

In some embodiments, the handover request frame may comprise at least one of current link configuration indicating current links of the non-AP MLD, new link configuration indicating desired links of the non-AP MLD, information indicating links which need to be added to multi-link operation of the non-AP MLD, information indicating links which need to be deleted from multi-link operation of the non-AP MLD, or information indicating a time after which transition from the current link configuration to the new link configuration occurs.

### BRIEF DESCRIPTION OF THE DRAWINGS

FIG. 1 shows an example of a wireless network 100 in accordance with an embodiment.

FIG. 2 shows an example of AP 101 in accordance with an embodiment.

FIG. 3 shows an example of STA 111 in accordance with an embodiment.

FIG. 4 shows an example of multi-link communication operation in accordance with an embodiment.

FIG. 5 shows a concept of a logical AP MLD in accordance with an embodiment.

FIG. 6 shows a concept of a logical AP MLD in accordance with another embodiment.

FIG. 7 shows a local stack in accordance with an embodiment.

FIG. 8 shows how the parallel stack and the local stack operate in accordance with an embodiment.

FIG. 9 shows operations of parallel stack in networks supporting centralized encryption in accordance with an embodiment.

FIG. 10 shows a method for setting up the parallel stack in networks supporting centralized encryption in accordance with an embodiment.

FIG. 11 shows architectural setup of parallel stack in networks supporting centralized encryption in accordance with an embodiment.

FIG. 12 shows operations of parallel stack in the network that does not support centralized encryption in accordance with an embodiment.

FIG. 13 shows a method for setting up the parallel stack in the network that does not support centralized encryption in accordance with an embodiment.

FIG. 14 shows architectural setup of parallel stack in the network that does not support centralized encryption in accordance with an embodiment.

FIG. 15 shows a method for dynamically setting up the parallel stack in the network in accordance with an embodiment.

FIG. 16 is a ladder diagram showing procedures for discovering the parallel stack in a passive manner.

FIG. 17 is a ladder diagram showing procedures for discovering the parallel stack in an active manner.

FIG. 18 is a flowchart showing a parallel stack discovery procedure for STA collocated with STA(s) that want to form a link with the parallel stack AP.

FIG. 19 is a flowchart showing a parallel stack advertisement procedure for an access point that is collocated with an AP that operates functionalities of the parallel stack.

FIG. 20 is a flowchart showing a procedure for a STA to request parallel stack information from the AP.

FIG. 21A shows a Link ID info field indicating whether the link is part of a parallel stack.

FIG. 21B shows a format of an element containing one or more Link ID bitmaps in accordance with an embodiment.

FIG. 22 is a flowchart showing an association procedure in accordance with an embodiment.

FIG. 23 is a ladder diagram showing a procedure requesting a handover.

FIG. 24 is a ladder diagram showing a context transfer procedure during a handover.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on wireless local area network (WLAN) communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

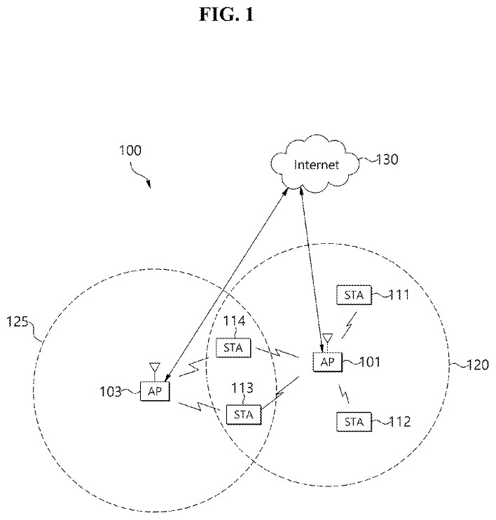

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs.

Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

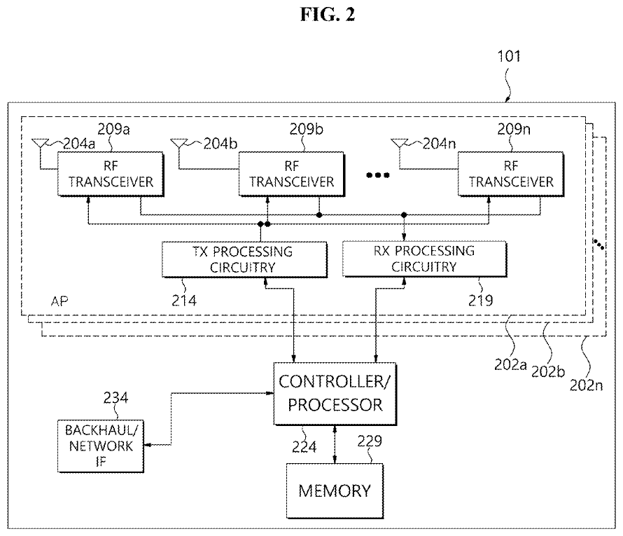

FIG. 2 shows an example of AP 101 in accordance with an embodiment. The embodiment of the AP 101 shown in FIG. 2 is for illustrative purposes, and the AP 103 of FIG. 1 could have the same or similar configuration. However, APs come in a wide range of configurations, and FIG. 2 does not limit the scope of this disclosure to any particular implementation of an AP.

As shown in FIG. 2, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2 illustrates one example of AP 101, various changes may be made to FIG. 2. For example, the AP 101 could include any number of each component shown in FIG. 2. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2 could be combined, further subdivided, or omitted and additional components could be added according to particular needs.

As shown in FIG. 2, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2 shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

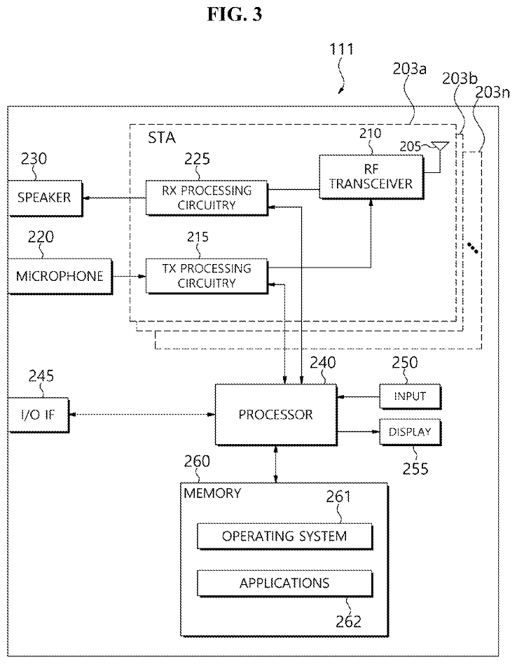

FIG. 3 shows an example of STA 111 in accordance with an embodiment. The embodiment of the STA 111 shown in FIG. 3 is for illustrative purposes, and the STAs 111-114 of FIG. 1 could have the same or similar configuration. However, STAs come in a wide variety of configurations, and FIG. 3 does not limit the scope of this disclosure to any particular implementation of a STA.

As shown in FIG. 3, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 3 shows one example of STA 111, various changes may be made to FIG. 3. For example, various components in FIG. 3 could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 3 illustrates the STA 111 configured as a mobile telephone or smartphone, STAs could be configured to operate as other types of mobile or stationary devices.

As shown in FIG. 3, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 3 shows that each STA 203a-203n has a separate antenna, but each STA 203a-203n can share the antenna 205 without needing separate antennas. Each STA 203a-203n may represent a physical (PHY) layer and a lower media access control (MAC) layer.

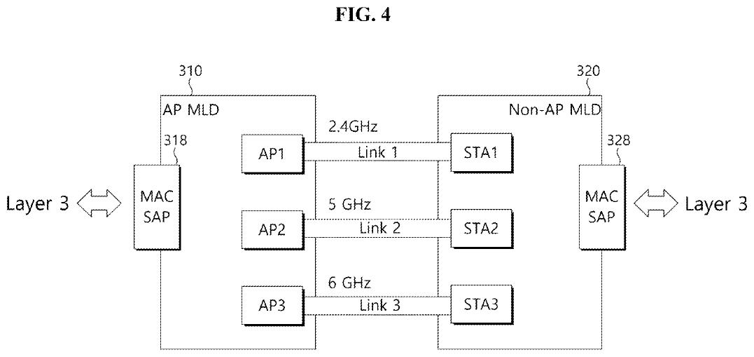

FIG. 4 shows an example of multi-link communication operation in accordance with an embodiment. The multi-link communication operation may be usable in IEEE 802.11be standard and any future amendments to IEEE 802.11 standard. In FIG. 4, an AP MLD 310 may be the wireless communication device 101 and 103 in FIG. 1 and a non-AP MLD 220 may be one of the wireless communication devices 111-114 in FIG. 1.

As shown in FIG. 4, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHz band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

In order to prioritize transmission of different types of traffic, which are identified by a traffic identifier (TID), across the setup links, the non-AP MLD 320 may negotiate a TID-to-link mapping with the AP MLD 310. The TID-to-link mapping allows the AP MLD 310 and the non-AP MLD 320 to determine how frames belonging to TIDs are assigned for transmission on each setup link in the uplink and downlink directions, respectively. When at least one TID associated with a non-AP MLD 320 is mapped to a setup link in either uplink or downlink direction, the link is referred to as an enabled link for the non-AP MLD 320. By default, all TIDs are mapped to all the setup links between the AP MLD 310 and the non-AP MLD 320, and this mapping is referred to as a default TID-to-link mapping. During association, the non-AP MLD 320 can use a negotiation procedure to negotiate a non-default mapping of TIDs to the setup links, by including a TID-to-Link Mapping element in an association request frame or a reassociation request frame. The non-default mapping can be either where all TIDs are mapped to the same subset of setup links, or where not all TIDs are mapped to the same subset of setup links. The AP MLD 310 can also use a broadcast procedure to indicate switching to a non-default mapping for all associated non-AP MLDs. In default mapping mode, all TIDs are mapped to all setup links for downlink and uplink and all setup links are enabled. The non-AP MLD 320 operates under default mapping mode when a TID-to-link mapping negotiation did not occur or was unsuccessful.

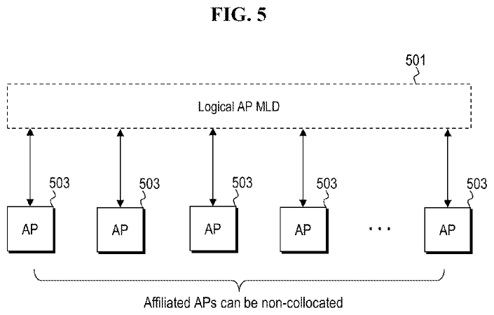

FIG. 5 shows a concept of a logical AP MLD in accordance with an embodiment.

The next generation Wireless Local Area Networks (WLANs) may aim to achieve low-latency with high reliability support. To attain this objective, one viable approach may involve the implementation of a logical AP MLD 501.

As depicted in FIG. 5, a logical AP MLD 501 may be made up of a plurality of APs 503 which may be non-collocated. The logical AP MLD 501 is different from the AP MLD specified in IEEE 802.11be, in that the AP MLD according to IEEE 802.11be considers collocated APs affiliated with the AP MLD. For example, when a first AP is affiliated with a first physical AP MLD and a second AP is affiliated with a second physical AP MLD, the first AP and the second AP may be referred to collectively as non-collocated APs. When a first AP and a second AP are affiliated with the same physical AP MLD, the first AP and the second AP may be referred to collectively as collocated APs.

In some embodiments, a plurality of APs 503 may be non-collocated. In some embodiments, one or more of the plurality of APs 503 may have a common data path to a router or a central controller. The APs shown in FIG. 5 may form the logical AP MLD 501. The logical AP MLD 501 may reduce the delays of association and authentication steps mentioned above as the STAs may not need to perform association and authentication during handover.

While the concept of the logical AP MLD 501 is very promising, a number of methods and procedures for setup and operation may be needed to realize this concept in next generation Wi-Fi networks.

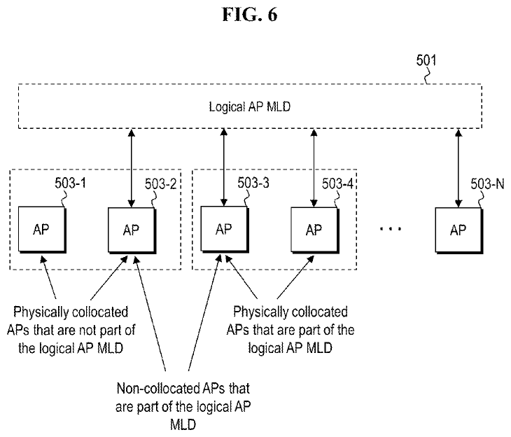

First, it may be necessary to specify the operation of the logical MLD architecture. Some of the APs affiliated with the logical AP MLD may also be affiliated with a different physical AP MLD. FIG. 6 shows a concept of a logical AP MLD in accordance with another embodiment. As depicted in FIG. 6, some of the AP STAs may be physically collocated and part of the logical AP MLD where as some of the AP STAs can be collocated with APs that are a part of the logical AP MLD. For example, the AP STA 503-2 which is a part of the logical AP MLD may be physically collocated with an AP STA 503-1 which is not a part of the logical AP MLD. The AP STA 503-3 which is a part of the logical AP MLD may be physically collocated with an AP STA 503-4 which is a part of the logical AP MLD. Methods and procedures that describe how various components of the logical AP MLD may be set up and interact with each other may be needed. Further, it may be necessary to define how various layers of the MAC architecture will be set up.

The discovery procedure also needs to be specified. Without a procedure to discover the logical AP MLD, the STA may not be aware of the existence of this framework at the AP side for mobility support. Consequently, the STA can fall back to one of the legacy procedures for mobility handling. Therefore, it may be necessary for an STA to be able to discover the logical AP MLD.

In addition, beaconing may be necessary. The logical AP MLD needs to perform beaconing in order to announce its presence, update various parameters, capability announcement, etc. However, this can increase beaconing overhead as physical AP MLDs also perform their own beaconing. Therefore, a procedure to perform efficient beaconing may be necessary. Further, it may be also necessary to design information that the logical AP MLD can share with the STA.

Procedures for link setup for logical AP MLD may also be necessary.

Finally, procedures for performing the handover using the logical AP MLD may be necessary.

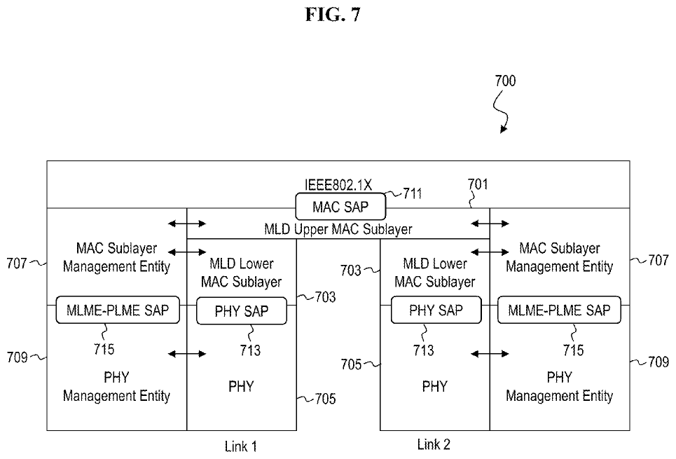

FIG. 7 shows a local stack in accordance with an embodiment.

For convenience, a setup of links from two collocated AP STAs as shown in FIG. 7 may be referred to as a local stack. The local stack may run on a physical AP MLD. For convenience, the local stack may be referred to interchangeably as collocated AP MLD, etc.

As shown in FIG. 7, the local stack 700 may operate on a plurality of links and comprise an MLD upper MAC sublayer 701, MLD lower MAC sublayers 703 for the links, PHY layers 705 for the links, MAC sublayer management entities (MLME) 707 for the links, PHY management entities (PLMEs) 709 for the links, an MAC service access point (SAP) 711, a PHY SAP 713, and an MLME-PLME SAP 715.

In an MLD, the MAC Sublayer may be divided into an MLD upper MAC sublayer 701 and an MLD lower MAC sublayer 703. The MLD upper MAC sublayer 701 may perform functionalities that are common across all links, and the MLD lower MAC sublayer 703 (shared with an AP or non-AP STA affiliated with the MLD) may perform functionalities that are local or specific to each link. Some of the functionalities may require joint processing of both the MLD upper MAC sublayer 701 and the MLD lower MAC sublayer 703.

The PHY management entity 709 may perform management of the local PHY functions of the PHY layer 705 in conjunction with the MLME 707.

The MAC SAP 711 may be located between an upper layer and the MAC sublayer as an interface for connecting the upper layer and the MAC sublayer. The MAC service access point MAC service data unit (MSDU) may be delivered as a unit between MAC service access points (SAPs) 711.

The PHY SAP 713 may be located between the MLD lower MAC sublayer 703 and the PHY layer 705 as an interface for connecting the MLD lower MAC sublayer 703 and the PHY layer 705.

The MLME-PLME SAP 715 may be located between the MLME 707 and the PLME 709 as an interface for connecting the MLME 707 and the PLME 709.

In some embodiments, all the sublayers shown in the FIG. 7, for example, including the MLD upper MAC sublayer 701 and the MLD lower MAC sublayer 703, may operate on the same physical AP MLD.

For convenience, the setup of various layers depicted in FIG. 7 when the plurality of links, for example, including a link 1 and a link 2 are setup from two non-collocated APs may be referred to as a parallel stack. For convenience, the parallel stack may be referred to interchangeably as non-collocated AP MLD, single mobility domain AP MLD, logical AP MLD, etc. in this disclosure.

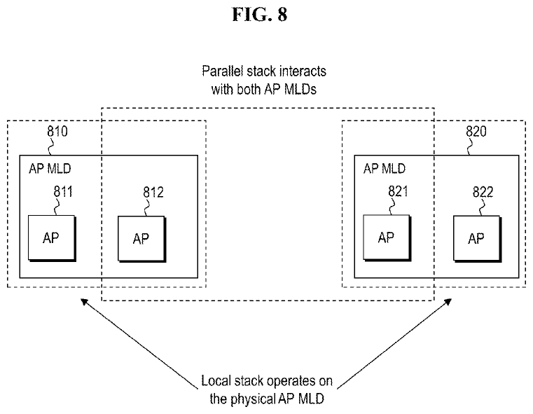

FIG. 8 shows how the parallel stack and the local stack operate in accordance with an embodiment.

FIG. 8 depicts a physical AP MLD 810 and a physical AP MLD 820. The physical AP MLD 810 comprises an AP STA 811 and an AP STA 812. The physical AP MLD 820 comprises an AP STA 821 and an AP STA 822.

As depicted in FIG. 8, a local stack for the physical AP MLD 810 may operate on the physical AP MLD 810 and a local stack for the physical AP MLD 820 may operate on the physical AP MLD 820 whereas the parallel stack can interact with both the AP MLDs.

Hereinafter, a Logical AP MLD architecture setup will be described referring to FIG. 8.

In some embodiments, all APs affiliated with an AP MLD may be a part of the parallel stack. For example, all APs 811, 812 affiliated with an AP MLD 810 may be a part of the parallel stack.

In some embodiments, one or more APs affiliated with an AP MLD may be excluded from the parallel stack operation. For example, the AP 812 affiliated with the AP MLD 810 may be a part of the parallel stack and the AP 811 affiliated with the AP MLD 810 may be excluded from the parallel stack operation.

In some embodiments, the APs may be excluded from the parallel stack based on a number of conditions. For instance, some of the APs may be turned down for power save, AP removal, etc. and may need to be not included in the parallel stack. In another example, when there may be too many APs and adding more APs may increase the complexity of the Logical AP MLD setup, some APs may be excluded from the parallel stack operation. In some embodiments, APs may be skipped if they do not support a particular feature for which the parallel stack will be used. For example, an AP may not be affiliated with the logical AP MLD if the AP does not support the mobility handover.

In some embodiments, an AP MLD may be forbidden from being a part of the logical AP MLD based on a lack of support for a particular feature. For example, an AP MLD may be forbidden from being a part of the logical AP MLD if the AP MLD does not support a feature that is required by devices that are using the Logical AP MLD or the feature for which the logical AP MLD is being setup. For example, the feature for which the logical AP MLD is being setup may be multi-AP coordination. In some embodiments, an AP MLD may be forbidden from being a part of the logical AP MLD stack if the central controller and the AP MLD are provided by different vendors and the implementations may not be compatible between the central controller and the AP MLD. In some embodiments, an AP MLD may be forbidden from being a part of the logical AP MLD when the AP MLD and the logical AP MLD are operated by different service providers and the AP MLD may not be qualified to become a part of the logical AP MLD setup by a service provider of the logical AP MLD.

In some embodiments, a plurality of components of the parallel stack may be implemented on different physical devices in different locations. For example, a first component of the parallel stack may be implemented on a first physical device in a first location and a second component of the parallel stack may be implemented on a second physical device in a second location. All the plurality of components of the parallel stack can interact over the backhaul to perform AP MLD operations.

In some embodiments, for the parallel stack operation, the MAC may be divided into two parts: a portion that is attributed to the collocated AP MLD and a portion that can be attributed to a different device. For example, the MAC may be divided into a lower MAC (LMAC) and an upper MAC (UMAC). The UMAC may handle various functionalities that are common for all the LMACs. For example, the common functionalities for all the LMACs may include authentication, association, disassociation, encryption, decryption, assignment of sequence number (SN) and packet number (PN), reorder buffer handling, replay detection, etc. The LMAC may handle other functionalities of the MAC that are specific to the link. For example, functionalities specific to the link may include A-MPDU De-aggregation, A-MPDU aggregation, MPDU Header+CRC creation, etc.

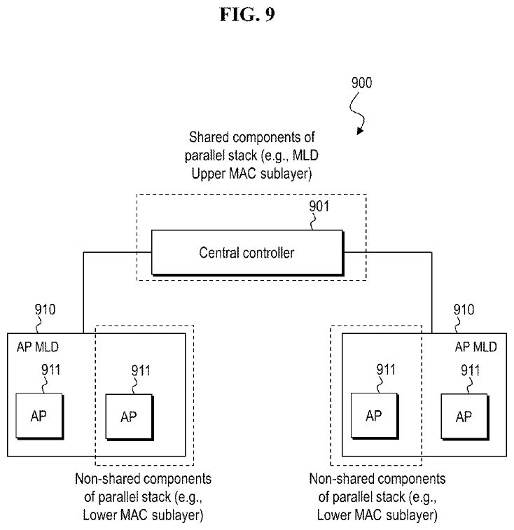

FIG. 9 shows operations of parallel stack in networks supporting centralized encryption in accordance with an embodiment.

As shown in FIG. 9, a network 900 that supports centralized encryption (e.g., enterprise networks) may comprise a central controller 901 and a plurality of AP MLDs. Each of the plurality of AP MLDs may comprise a plurality of AP STAs. In some embodiments, the network 900 may further comprise one or more AP STAs which are not affiliated with any AP MLDs.

For the network 900 that supports centralized encryption, the common shared components of the parallel stack (e.g., MLD upper MAC sublayer) may operate on the central controller 901 as shown in FIG. 9.

In accordance with the embodiment as shown in FIG. 9, the parallel stack may comprise shared components included in the central controller 910 and non-shared components included in the AP MLDs 910. In some embodiments, the parallel stack may be set up by the MLD upper MAC sublayer of the central controller and the MLD lower MAC sublayers of the AP MLDs 910.

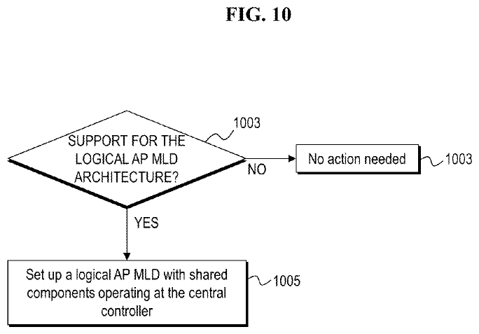

FIG. 10 shows a method for setting up the parallel stack in networks supporting centralized encryption in accordance with an embodiment.

Referring to FIG. 10, in operation 1001, the central controller 901 may determine whether it supports a logical AP MLD architecture.

If the central controller 901 does not support the logical AP MLD architecture, it takes no action, in operation 1003.

If the central controller 901 supports the logical AP MLD architecture, it sets up the logical AP MLD with the shared components operating at the central controller 901 and non-shared components operating at the physical AP MLDs 910, in operation 1005.

FIG. 11 shows architectural setup of parallel stack in networks supporting centralized encryption in accordance with an embodiment.

Referring to FIG. 11, a network 1100 supporting centralized encryption in accordance with an embodiment may comprise a traffic entry point 1110, a central controller 1120, and a plurality of AP MLDs 1130. The central controller 1120 may comprise an MLD upper MAC sublayer 1121 for a parallel stack. Each of the plurality of AP MLDs 1130 may comprise an MLD upper MAC sublayer 1131 for a local stack, a plurality of MLD lower MAC sublayers 1132 for multiple links, and a plurality of PHY layers 1133 for multiple links.

The traffic coming into or leaving the network 1100 may be divided into traffic that is intended for the local stack and traffic that is intended for the parallel stack. The traffic that is intended for the local stack may be referred to as local stack traffic, and the traffic that is intended for the parallel stack may be referred to as parallel stack traffic.

In some embodiments, the MLD upper MAC sublayer 1131 running on a respective one AP MLD 1130, the MLD lower MAC sublayers 1132 running on the respective one AP MLD 1130, and a plurality of PHY layers 1133 running on the respective one AP MLD 1130 may form the local stack. In some embodiments, the MLD upper MAC sublayer 1121 running on the central controller 1120, the MLD lower MAC sublayers 1132 running on AP MLDs 1130, and a plurality of PHY layers 1133 running on AP MLDs 1130 may form the parallel stack.

The traffic entry point 1110 receives traffic from an external network. If the received traffic is the local stack traffic, the local stack traffic may be forwarded to the MLD upper MAC sublayer 1131. If the received traffic is the parallel stack traffic, the local stack traffic may be forwarded to the MLD upper MAC sublayer 1121.

If the MLD lower MAC sublayers 1132 receives local stack traffic, it forwards the traffic to the MLD upper MAC sublayer 1131 and the MLD upper MAC sublayer 1131 forwards the traffic to the traffic entry point 1110. If the MLD lower MAC sublayers 1132 receives parallel stack traffic, it forwards the traffic to the MLD upper MAC sublayer 1121 and the MLD upper MAC sublayer 1121 forwards the traffic to the traffic entry point 1110.

Thus, the local stack traffic may be forwarded to the MLD upper MAC sublayer 1131 of the local stack whereas the traffic of the parallel stack may be forwarded to the device where the MLD upper MAC sublayer 1121 of the parallel stack operates. The MLD upper MAC sublayer 1121 of the parallel stack can handle the traffic of the parallel stack and the MLD upper MAC sublayer 1131 of the local stack can handle the traffic of the local stack.

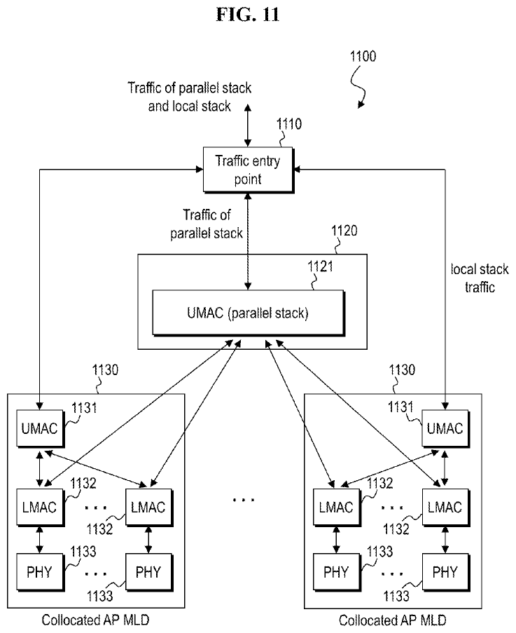

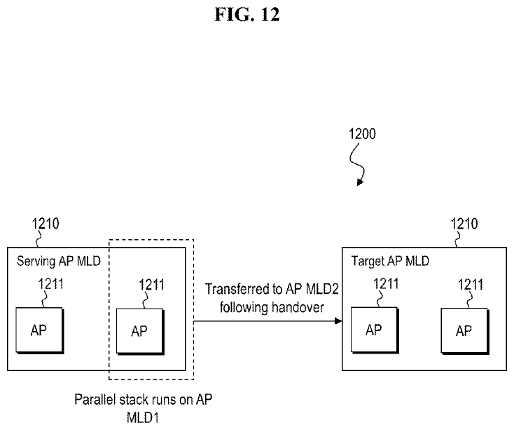

FIG. 12 shows operations of parallel stack in the network that does not support centralized encryption in accordance with an embodiment.

As shown in FIG. 12, a network 1200 that does not support centralized encryption (e.g., home networks) may comprise a plurality of AP MLDs 1210. Each of the plurality of AP MLDs 1210 may comprise a plurality of AP STAs 1211.

In some embodiments, for the network 1200 that does not support centralized encryption, the components of the parallel stack (e.g., MLD upper MAC sublayer) may operate on one of the plurality of AP MLDs 1210 and may be transferred from a serving AP MLD to the target AP MLD when handover is initiated by the STA as shown in FIG. 12. The AP MLD which the STA is currently associated with may be referred to as the serving AP MLD and the AP MLD that the STA intends to move to after transition is complete may be referred to as the target AP MLD.

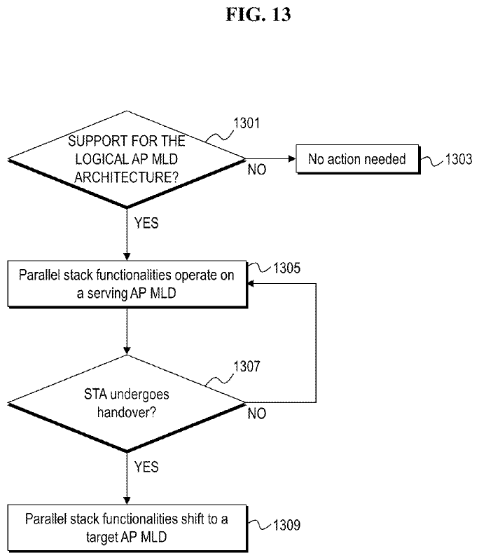

FIG. 13 shows a method for setting up the parallel stack in the network that does not support centralized encryption in accordance with an embodiment.

Referring to FIG. 13, in operation 1301, a serving AP MLD may determine whether it supports a logical AP MLD architecture.

If the serving AP MLD does not support the logical AP MLD architecture, it takes no action, in operation 1303.

If the serving AP MLD supports the logical AP MLD architecture, it sets up the logical AP MLD and the parallel stack functionalities operates on the serving AP MLD, in operation 1305.

The serving AP MLD determines whether the STA associated with the serving AP MLD undergoes handover in operation 1307.

If the STA associated with the serving AP MLD undergoes handover, the serving AP MLD shifts the parallel stack functionalities to a target AP MLD and the parallel stack functionalities operates on the target AP MLD, in operation 1309.

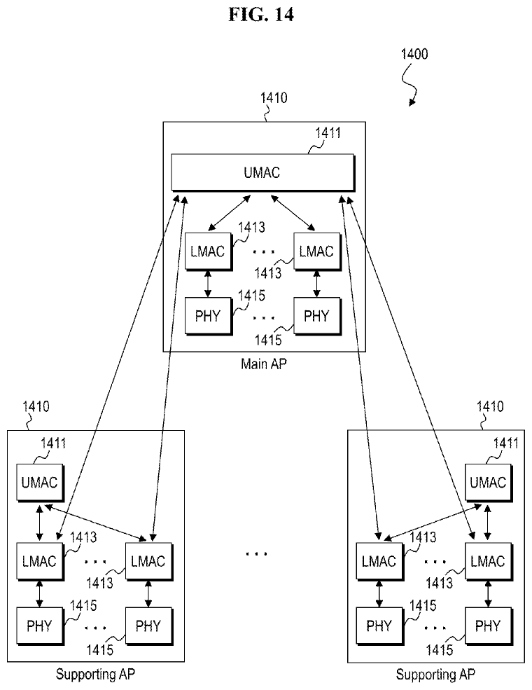

FIG. 14 shows architectural setup of parallel stack in the network that does not support centralized encryption in accordance with an embodiment.

Referring to FIG. 14, the network 1400 that does not support centralized encryption in accordance with an embodiment may comprise a plurality of AP MLDs 1410. Each of the plurality of AP MLDs 1410 may comprise an MLD upper MAC sublayer 1411, a plurality of MLD lower MAC sublayers 1413 for multiple links, and a plurality of PHY layers 1415 for multiple links. At least one AP MLD may operate as a main AP MLD having the functionalities of the parallel stack and the others may operate as supporting AP MLDs. When handover occurs from the main AP MLD to a supporting AP MLD, the main AP MLD may correspond to the serving AP MLD and the supporting AP MLD may correspond to the target AP MLD.

The MLD upper MAC sublayer 1411 of the main AP MLD may operate as a MLD upper MAC sublayer for both the parallel stack and the local stack. The MLD upper MAC sublayers 1411 of the supporting AP MLDs may operate as MLD upper MAC sublayers for the local stack. Thus, an MLD upper MAC sublayer for the parallel stack may run on the main AP MLD and MLD lower MAC sublayers for the parallel stack may run on the main AP MLD and the supporting AP MLD.

If the MLD lower MAC sublayers 1413 of the supporting AP MLD receives local stack traffic, it forwards the traffic to the MLD upper MAC sublayer 1411 of the supporting AP MLD. If the MLD lower MAC sublayers 1413 of the supporting AP MLD receives parallel stack traffic, it forwards the traffic to the MLD upper MAC sublayer 1411 of the main AP MLD.

If the MLD upper MAC sublayers 1411 of the main AP MLD receives local stack traffic, it forwards the traffic to the MLD lower MAC sublayer 1413 of the main AP MLD. If the MLD upper MAC sublayers 1411 of the main AP MLD receives parallel stack traffic, it forwards the traffic to an MLD lower MAC sublayer 1413 to which the traffic is addressed.

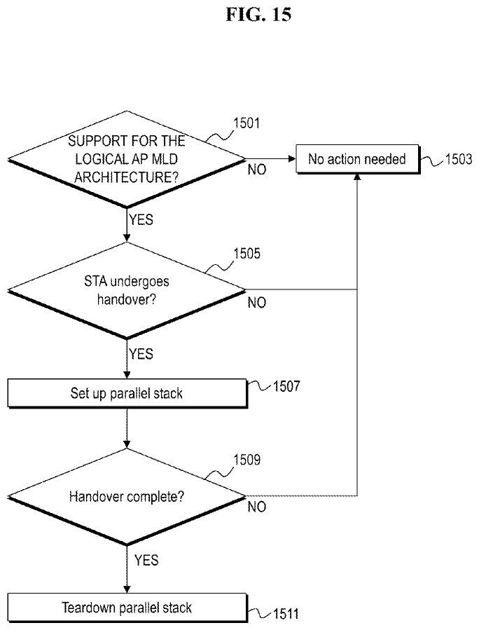

In some embodiments, the parallel stack may be set up for long term use. For instance, a number of APs affiliated with various AP MLDs in an enterprise network may set up a parallel stack for mobility handling. In some embodiments, the parallel stack may be dynamically set up and torn down depending on the need. For instance, the parallel stack may be set up for mobility handling on a need basis and may be torn down once handover is complete as depicted in FIG. 15.

FIG. 15 shows a method for dynamically setting up the parallel stack in the network in accordance with an embodiment.

Referring to FIG. 15, in operation 1501, an AP MLD may determine whether it supports a logical AP MLD architecture.

If the AP MLD does not support the logical AP MLD architecture, it takes no action, in operation 1503.

If the AP MLD supports the logical AP MLD architecture, it may determine whether the STA associated with the AP MLD undergoes handover, in operation 1505.

If the STA associated with the AP MLD undergoes handover, the AP MLD may set up the logical AP MLD, in operation 1507.

And then, the AP MLD determines whether the handover is complete, in operation 1509. If the handover is not complete, the AP MLD takes no action.

If the handover is complete, the AP MLD may tear down the parallel stack, in operation 1511.

Hereinafter, procedures for discovering the parallel stack will be described in accordance with various embodiments.

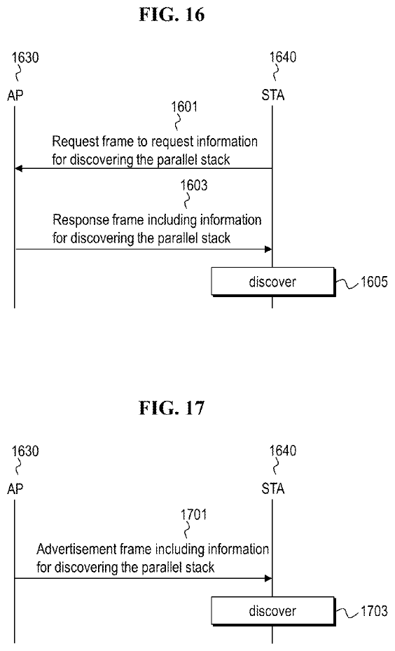

FIG. 16 is a ladder diagram showing procedures for discovering the parallel stack in a passive manner.

In operation 1601, the STA 1640 may transmit a request frame to request information for discovering the parallel stack to the AP 1630.

In operation 1603, the AP 1630 may transmit a response frame including information for discovering the parallel stack in response to the request frame. In some embodiments, the response frame may be a management frame such as beacons, probe response frames, (Re) association response frames.

In operation 1605, the STA 1640 may discover the parallel stack based on the information in the received frame.

FIG. 17 is a ladder diagram showing procedures for discovering the parallel stack in an active manner.

In operation 1701, the AP 1630 may advertise information for discovering the parallel stack by transmitting an advertisement frame including the information for discovering the parallel stack. In some embodiments, the advertisement frame may be a management frame such as beacons, probe response frames, (Re) association response frames.

In operation 1703, the STA 1640 may discover the parallel stack based on the information in the received frame.

Referring to FIG. 16 and FIG. 17, the STA 1640 may correspond to an STA affiliated with a non-AP MLD, a non-AP MLD, an STA affiliated with a non-AP MLD that will form a link with an AP affiliated with the AP MLD which is a part of the parallel stack, or an STA affiliated with a non-AP MLD that will not form a link with an AP affiliated with an AP MLD which is a part of the parallel stack.

In some embodiments, an STA 1640 (e.g., STA affiliated with a non-AP MLD) may discover if an AP 1640 or an AP MLD has set up a parallel stack for mobility support. In some embodiments, an STA 1640 (e.g., STA affiliated with a non-AP MLD) may discover if an AP 1640 or an AP MLD has the capability to set up a parallel stack for mobility support.

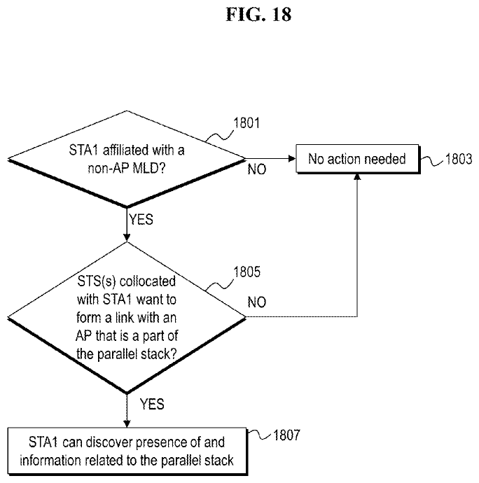

FIG. 18 is a flowchart showing a parallel stack discovery procedure for STA collocated with STA(s) that want to form a link with the parallel stack AP.

In operation 1801, a first station STA1 may determine which the first station STA1 is affiliated with a non-AP MLD.

If the first station STA1 is not affiliated with a non-AP MLD, the first station STA1 may take no action, in operation 1803.

If the first station STA1 is affiliated with a non-AP MLD, the first station STA1 may determine which at least one station collocated with the first station STA1 wants to form a link with an AP that is a part of the parallel stack, in operation 1805.

If any station collocated with the first station STA1 does not want to form a link with an AP that is a part of the parallel stack, the first station STA1 may take no action, in operation 1803.

If at least one station collocated with the first station STA1 wants to form a link with an AP that is a part of the parallel stack, the first station STA1 may discover presence of and information related to the parallel stack, in operation 1807.

Referring to FIG. 16 again, the request frame may contain at least one or more of the information items as indicated in Table 1. Table 1 shows information items that can be present in the message for discovering the parallel stack.

TABLE 1

| Information | |
|---|---|
| items | Description |
| Non-AP MLD | An information item that can identify the non-AP MLD. |
| identifier | E.g., non-AP MLD MAC address. |
| Parallel stack | An information item that can indicate the non-AP MLD's |
| association | intent to associate with the parallel stack. E.g., a |
| intent | flag or a field that can take a predetermined value |
| | based on an encoding to make the indication. |

Some embodiments allow both a physical AP MLD and a logical AP MLD to independently advertise their presence and to independently respond to probe requests. However, this may cause inefficiency and make waste of wireless resources. To avoid this problem, the non-AP MLD may make an indication as in Table 1 when performing a discovery.

The information items in Table 1 may be transmitted together or separately. They may be transmitted as a part of any existing frame/element/field/subfield in the standard or may be a part of newly defined ones.

In some embodiments, identifiers such as AP MLD ID may be assigned to non-collocated AP MLDs. These identifiers may be absolute in nature instead of being relative.

Referring to FIG. 16 and FIG. 17, the AP 1630 may correspond to an AP MLD, an AP affiliated with an AP MLD, an AP affiliated with the AP MLD which is a part of the parallel stack, or an AP affiliated with the AP MLD which is not a part of the parallel stack and is collocated with an AP affiliated with the same AP MLD which is a part of the parallel stack. In some embodiments, an AP 1630 (e.g., AP affiliated with an AP MLD) may advertise the presence of the parallel stack and/or its capability to set up the parallel stack.

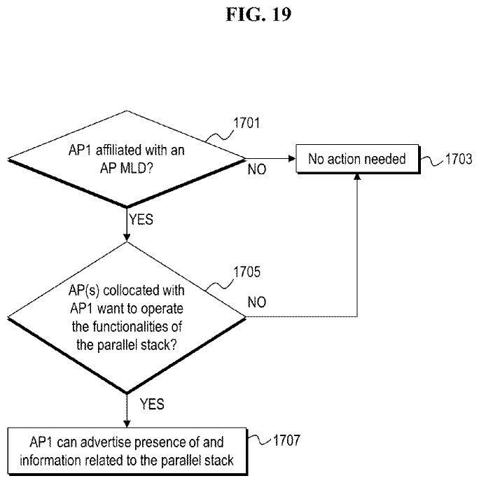

FIG. 19 is a flowchart showing a parallel stack advertisement procedure for an access point that is collocated with an AP that operates functionalities of the parallel stack.

In operation 1901, a first access point AP1 may determine which the first access point AP1 is affiliated with an AP MLD.

If the first access point AP1 is not affiliated with an AP MLD, the first access point AP1 may take no action in operation 1903.

If the first access point AP1 is affiliated with an AP MLD, the first access point AP1 may determine which at least one access point collocated with the first access point AP1 wants to operate the functionalities of the parallel stack in operation 1905.

If any access point collocated with the first access point AP1 does not want to operate the functionalities of the parallel stack, the first access point AP1 may take no action in operation 1903.

If at least one access point collocated with the first access point AP1 wants to operate the functionalities of the parallel stack, the first access point AP1 may advertise presence of and information related to the parallel stack in operation 1907.

In some embodiments, when an AP 1630 advertises the parallel stack or transmit information for discovering the parallel stack, it may transmit an advertisement message to the STA 1640 that contains at least one or more of the information fields indicated in Table 2. In some embodiments, these information fields may be included in the response frame as shown in FIG. 16. In some embodiments, these information fields may be included in the advertisement frame as shown in FIG. 17. Table 2 shows information fields that can be transmitted by the AP to the STA.

TABLE 2

| Information item | Description |
|---|---|
| MLD | An information item to indicate whether any of the APs affiliated |
| Capability/non- | with the AP MLD can be a part of the parallel stack or alternatively |
| collocated AP MLD | whether the AP MLD has the capability to host the parallel stack. |
| support identifier | For instance, this can be a bit value that can be set to 1 to indicate |
| | that one or more of the APs affiliated with the AP MLD with which |
| | the advertising AP is affiliated can be a part of the parallel stack. |
| Parallel stack | An identifier for a parallel stack. E.g., parallel stack ID, MAC |
| identifier | address, etc. |
| Status identifier | A field to indicate the status of the parallel stack setup. For instance, |
| | this can be a bit that can be set to 1 to indicate that the parallel stack |
| | has been setup and 0 to indicate that it is not setup. |
| Parallel stack | A field to indicate the APs affiliated with the AP MLD that are a |
| collocated AP | part of the parallel stack. For instance, this can be a bit map in |
| identifier | which the a value of 1 can be set corresponding to AP1 if AP1 is a |
| | part of the parallel stack and 0 if AP1 is not a part of the parallel |
| | stack. This information can help the non-AP MLD/STA to |
| | understand whether legacy roaming procedure needs to be used for |
| | transition from current AP to new AP. |
| Parallel stack non- | A field to indicate which AP MLDs are a part of the parallel stack |
| collocated AP | setup at the indicating AP MLD. For instance, for each AP MLD |
| identifier | that is a part of the parallel stack, their identifier (e.g., AP MLD ID, |
| | MAC address, MLD MAC address etc.) can be indicated. (e.g., as a |
| | list). Further for each AP MLD, the list can also contain a list of |
| | affiliated APs that are a part of the parallel stack. |
| Duration | Duration for which the parallel stack will be hosted. E.g., this can be |
| | indicated in terms of TBTT. |
| Parallel stack | An information item that can indicate that the advertisement |
| indication | corresponds to a parallel stack. E.g., a flag, a field (e.g., a bit) that |
| | can take a predetermined value to make such an indication. |
| Non-collocation | One or more information items that can indicate whether the AP |
| indicator | identifiers mentioned above correspond to local stack or parallel |
| | stack. |
| PHY capabilities | One or more information items that can describe the PHY |
| | capabilities of the parallel stack. E.g., supported rates, supported |
| | features such as RTWT, etc. |
| PHY constraints | One or more information items that can describe the PHY |
| | constraints of the parallel stack. E.g., NSTR constraints, power save |
| | constraints, etc. |
| PHY configuration | One or more information items that can describe the configuration |
| | of the PHY. E.g., the channel configuration, bandwidth, etc. |
| Traffic status | One or more information items that can describe the traffic status |
| | (e.g., load, number of associated devices, etc.) of the parallel stack. |

The above information items in Table 2 may be transmitted together or separately. They may be transmitted as a part of any existing frame/element/field/subfield in the standard or can be a part of newly defined ones. The frame including the information items as shown in Table 2 may be a management frame such as beacons, probe response frames, (Re) association response frames, etc.

In some embodiments, the above information may be carried in an element that is transmitted by the parallel stack in one or more frames that it transmits. E.g., management frames such as beacons, probe responses, (Re) association responses, etc. When the STA/non-AP MLD receives such a frame from the parallel stack, it can discover the parallel stack. Based on the non-collocation indication, the STA/non-AP MLD can also understand the setup of the parallel stack and which of its APs are collocated and which are non-collocated.

In some embodiments, the APs that are collocated can include the MLD MAC address of the non-collocated AP MLD in a modified basic multi-link element of the beacon frame. A modified reduced neighbor report (RNR) element can also include the information of the non-collocated AP MLD.

In some embodiments, an AP MLD may host more than one parallel stack. Each of the more than one parallel stack may have its own identifier. For example, the identifier may be a parallel stack ID or a MAC address, etc. In some embodiments, if the AP MLD hosts more than one parallel stack, the advertising AP may advertise information indicated in Table 2 for each parallel stack that the AP MLD hosts.

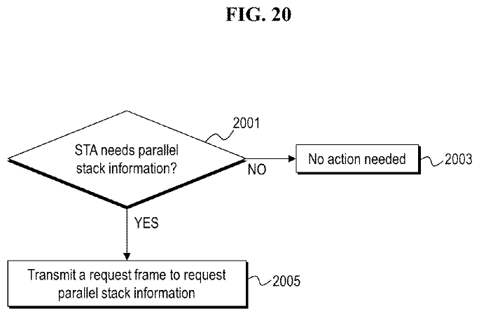

In some embodiments, the above information shown in Table 2 may be requested by an STA affiliated with a non-AP MLD by transmitting a request message to an AP affiliated with an AP MLD as depicted in FIG. 20.

FIG. 20 is a flowchart showing a procedure for a STA to request parallel stack information from the AP.

In operation 2001, a STA 1630 may determine whether the STA 1630 needs parallel stack information.

If the STA 1630 does not need parallel stack information, the STA 1630 may take no action, in operation 2003.

If the STA 1630 need parallel stack information, the STA 1630 may transmit a request frame to request parallel stack to the AP 1640, in operation 2005.

In some embodiments, when the AP 1640 receives a request message from the STA 1630, the AP 1640 may transmit a response message containing one or more of the information fields indicated in Table 2 in a frame to the STA.

In some embodiments, the request message may be included in either a new frame or any of the existing frames in the standard. For example, the request message may be included in a probe request frame, etc. Similarly, the response message may be included in either a new frame or any of the existing frames in the standard. For example, the response message may be included in a probe response frame, etc.

In some embodiments, the AP 1630 may advertise the information for each of parallel stacks that the AP MLD hosts in frames that it transmits to the STA 1640. In some embodiments, the STA 1640 that receives such frames may discover the parallel stack and its configuration. The information can be advertised in an independent frame or in any of the frames existing in the standard. The frame that is used for advertisement can contain at least one or more of the information items indicated in Table 3. Table 3 shows information items that can be present in the advertisement frame.

TABLE 3

| Information item | Description |
|---|---|
| AP identifier(s) | An identifier(s) for any AP that is affiliated with the parallel stack |
| | (e.g., MAC address). This AP can be collocated with the advertising |
| | AP or can be non-collocated or the advertising AP itself. |
| MLD identifier(s) | An identifier(s) for the MLD that is also hosting this parallel stack |
| | (e.g., MLD MAC address). This MLD can be the same MLD or a |
| | non-collocated MLD. |
| Capabilities | The description of the capabilities of the MLD(s) that hosts the |
| | parallel stack. This can be the MAC and/or PHY layer capabilities. |
| | E.g., capability to support for a specific feature. |

The above information may be present in any of the frames or elements transmitted with the frames in the standard. In some embodiments, the information items as shown in Table 3 may be included in a basic multi-link element in a beacon frame. In some embodiments, the information items as shown in Table 3 may be included in a reduced neighbor report (RNR) element. In some embodiments, any of the existing frames may also be extended to include the above information. For example, when the above information is included in a reduced neighbor report element, the information may be included in a newly defined extension of the frame or the element. When an AP 1640 advertises information related to the AP MLD with which it is affiliated and the AP MLD with which it is not affiliated (e.g., an AP MLD that also hosts the parallel stack which the AP 1640 is a part of), the information related to all or one or more of the AP MLDs with which that the AP 1640 are not affiliated may be skipped in some cases (e.g., if there can be a beacon bloating issue). For example, if there is a beacon bloating issue, the information may be skipped.

In some embodiments, a non-AP MLD that is capable of associating and operating with a logical AP MLD framework may advertise its capability to do so. The non-AP MLD may advertise its capability in one or more frames that it transmits through any of its affiliated non-AP STAs. In some embodiments, the frame may be an independent frame or can be any of the existing frame in the standard. For example, the frame may be a management frames such as probe request frames.

Hereinafter, procedures for beaconing will be described in accordance with various embodiments.

In some embodiments, the parallel stack can transmit its own beacon frames to signal information related to the parallel stack. The information related to the parallel stack may be similar to an AP MLD advertising information in beacon frames. The beacon frames may be transmitted via APs that are affiliated with the parallel stack.

If the local stack and the parallel stack independently perform beaconing, beaconing overhead may increase. In some embodiments, the parallel stack may not transmit its own beacon frames. Instead, the information of the parallel stack can be included in beacons that APs affiliated with the physical APs transmit. This can help to reduce the beaconing overhead. The information in the beacon for the parallel stack can be the same as that for an AP MLD. The information in the beacon for the parallel stack can further contain one or more information items indicated in Table 2.

In some embodiments, the APs that are collocated may include the information of other APs that are collocated with them in RNR element. The information of APs that are not collocated may be excluded.

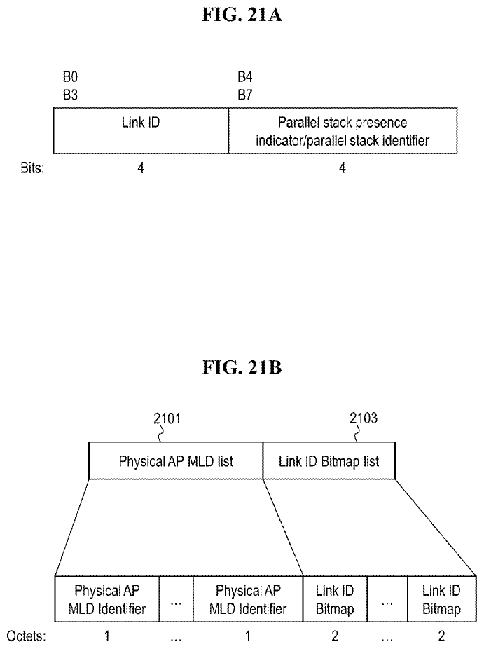

Hereinafter, the link ID management in accordance with various embodiments will be described with reference to FIG. 21A and FIG. 21B.

FIG. 21A shows a Link ID info field indicating whether the link is part of a parallel stack.

As shown in FIG. 21A, a Link ID info field may include a Link ID subfield and a parallel stack presence indicator/parallel stack identifier subfield. The parallel stack presence indicator/parallel stack identifier subfield may include a parallel stack presence indicator subfield and a parallel stack identifier subfield.

In some embodiments, the Link ID info field may be included in the beacon frame, the association request frame, the association response frame, the reassociation request frame, the reassociation response frame, the probe response frame, and the authentication frame.

The Link ID subfield of the Link ID Info field may indicate the identifier of the link. In some embodiments, the link ID is an integer value between 0 and 14 that uniquely identifies an AP affiliated with the AP MLD.

In some embodiments, when an AP transmits a frame (frame can be a frame corresponding to the parallel stack) containing Link ID info field, it can make an indication indicating whether the link is a part of the parallel stack or not as depicted in FIG. 21A. In some embodiments, the indication can be made via the parallel stack presence indicator subfield which can be set to 1 if the link is a part of the parallel stack and set to 0 if it is not a part of the parallel stack. In some embodiments, a parallel stack identifier subfield can be included to make this indication. This can be an identifier of the parallel stack itself.

In some embodiments, each link that is a part of the parallel stack can have its own link ID.

In some embodiments, link IDs that are assigned to the local stack can be reused for the parallel stack. However, this may result in duplication of link IDs. In such a situation, an additional field/information item can be used to indicate which physical AP MLDs the links are associated with. One or more additional fields or one or more information items can be used together with the link ID for link identification. The field(s)/information item(s) that can be grouped together for link identification can be one or more of those indicated in Table 4. Table 4 shows information items that can be used for link identification.

TABLE 4

| Information item | Description |
|---|---|
| Link identifier | An information item that can identify the link. For example, the Link |
| | identifier may be the link ID used in the context of the collocated AP |
| | MLD. |
| AP MLD identifier | An information item that can indicate the AP MLD which the link can |
| | be attributed to. This can be the collocated AP MLD address. For |
| | example, the collocated AP MLD can be allocated an identifier and |
| | this identifier together with the link ID can be used for link |
| | identification purposes. In another example, the MLD MAC address |
| | of the collocated AP MLD can be used as the AP MLD identifier. |
| Extra identifier | An information item in addition to the above two information items. |
| | For example, this may be a non-collocated AP MLD address or |
| | extended AP MLD identification, etc. |

For instance, if a parallel stack has two links with the same link ID (say x and x), there may be an additional field or an information item such as identifiers of corresponding physical AP MLDs respectively which the two links belong to. Assuming the value of the link ID of the first and second links is ‘x’, the AP MLD identifier of the first physical AP MLD which the first link belong to is ‘a,’ and the AP MLD identifier of the second physical AP MLD which the second link belong to is ‘b,’ the link IDs of the two links may be signaled together with the identifier of the first and second physical AP MLDs, respectively. In this scenario, for the purpose of identifying links in the parallel stack, the link IDs of the two links may correspond to <x, a> and <x, b>, respectively. In some embodiments, when the link ID is being reused (e.g., between a local stack and a parallel stack and/or between different APs of the same parallel stack), additional parameters may be used together with the link ID to identify the links. For instance, the link ID can be coupled together with other parameters such as the AP MLD identifier or a MAC address of an AP MLD. In this example, a tuple can be created which comprises or is composed of the MLD MAC address and the link ID and this tuple can be used to differentiate between the links.

FIG. 21B shows a format of an element containing one or more Link ID bitmaps in accordance with an embodiment.

In some embodiments, the logical AP MLD can support one or more features in addition to mobility management. In this scenario, a single link ID bitmap that is a part of several signaling mechanisms may not be useful anymore as it may be not sufficient to make an indication for all the links.

In some embodiments, referring to FIG. 21B, a tuple of two lists may be used. The first list may be a physical AP MLD list 2101 and the second list may be a link ID bitmap list 2103. In some embodiments, an AP STA affiliated with the logical AP MLD may transmit a frame containing the physical AP MLD list 2101 and link ID bitmap list 2103 to a non-AP STA associated with the logical AP MLD.

The physical AP MLD list 2101 may carry identifiers of physical AP MLDs that host the parallel stack. The link ID bitmap list 2103 may be a list of Link ID bitmaps arranged in the same manner as the identifiers of the physical AP MLDs in the physical AP MLD list 2101. The bitmaps in the Link ID bitmap list 2103 may be associated with a respective one of the physical AP MLDs in the physical AP MLD list 2101. Each bitmap of bitmaps in the Link ID bitmap list 2103 may be used to indicate links that are formed by that an associated physical AP MLD.

Hereinafter, the association will be described in accordance with various embodiments.

In some embodiments, when searching for or discovering the parallel stack, the non-AP MLD may transmit a message indicating its intent to associate with the parallel stack. Upon receiving the message, if the message indicates the intent to associate with the parallel stack, the response of the parallel stack can be transmitted to the non-AP MLD.

In some embodiments, when associating with the parallel stack, the non-AP MLD can transmit a message indicating its intent to associate with the parallel stack. Upon receiving the message, if the message indicates the intent to associate with the parallel stack, the response of the parallel stack can be transmitted to the non-AP MLD.

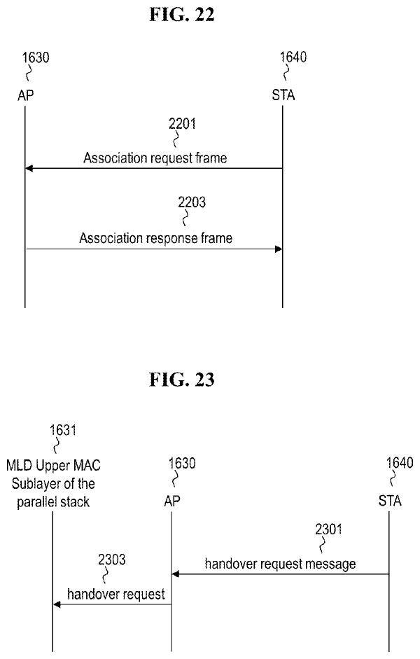

FIG. 22 is a flowchart showing an association procedure in accordance with an embodiment.

As shown in FIG. 22, in operation 2201, the STA 1640 affiliated with a non-AP MLD may transmit an association request frame to the AP 1630 affiliated with an AP MLD.

In operation 2203, the AP 1630 may transmit an association response frame to the STA 1640 in response to the association request frame. The association response frame may contain an association identifier (AID). The AID may be a value assigned by the AP MLD or the AP 1630 affiliated with the AP MLD during association.

In some embodiments, the AID assigned at the local stack or the collocated AP MLD level may be coupled together with an information item for use at the non-collocated AP MLD level. The information item may be one or more of those mentioned in Table 5. Table 5 shows information items that can be used to differentiate AID at non-collocated AP MLD level.

TABLE 5

| Information item | Description |
|---|---|
| AID | The AID assigned at the collocated AP MLD level. In some |
| | embodiments, the AID may also be separately assigned at the non- |
| | collocated AP MLD level. |
| AP MLD identifier | An information item that can indicate the AP MLD. This may be the |
| | collocated AP MLD address. In some embodiments, the collocated AP |
| | MLD may be allocated an identifier and this identifier can be used |
| | together with the AID for link identification purposes. In some |
| | embodiments, the MLD MAC address of the collocated AP MLD may |
| | be used as the AP MLD identifier. |

Hereinafter, the Handover procedure in accordance with various embodiments will be described with reference to FIG. 23.

FIG. 23 is a ladder diagram showing a procedure requesting a handover.

When a non-AP MLD performs a switch from a serving AP MLD to a target AP MLD during handover, the non-AP MLD may request a reconfiguration of its links instead of association. In operation 2301, the non-AP MLD may make an indication to the AP MLD to do so and the STA 1640 affiliated with the non-AP MLD may transmit a frame including a handover request message containing one or more of information fields indicated in Table 6. Table 6 shows information fields that the non-AP MLD can transmit to AP MLD when it performs handover.

TABLE 6

| Field | Description |
|---|---|
| Current link | One or more information items that can be used to indicate the STA's |
| configuration | current link configuration to the AP. In some embodiments, this may |
| | be done by using a list of tuples of links as described in the link ID |
| | management section above. In some embodiments, assuming a non- |
| | AP MLD has two STAs including STA1 and STA2 which form link 1 |
| | and link 2 with AP 1 and AP2 affiliated with AP MLD1 and a physical |
| | AP MLD identifier of the AP MLD1 is ‘a’, the current link |
| | configuration can be indicated as a list of tuples [<<1, a>, <2, a>>]. |
| New link | One or more information items that can be used to indicate to the AP |
| configuration | about the new desired link configuration. For instance, assuming a |
| | non-AP MLD above wants to move to AP MLD2 which has link 1 and |
| | link 2 and a physical AP MLD identifier of the AP MLD2 is ‘b’, the |
| | non-AP MLD can indicate the new link configuration as a list of tuples |
| | [<<1, b>, <2, b>>]. This may indicate the new links of the new AP |
| | MLD with which STA1 and STA2 of non-AP MLD want to be |
| | connected to. |
| Links to add | An information item that can be used to indicate the new links that |
| | need to be added to the non-AP MLD's operation. |
| Links to delete | An information item that can be used to indicate the existing links that |
| | need to be deleted from the non-AP MLD's operation. |
| Transition time | An information item that can indicate the time after which the |
| | transition to the new configuration occurs. In some embodiments, this |
| | can also be the time for which the current configuration is retained. |
| | For example, this may be the number of TBTTs from the current TBTT |
| | after which the new link configuration takes effect, the time duration |
| | value, etc. |

In some embodiments, the information items as shown in Table 6 may be transmitted together or separately. In some embodiments, the information items as shown in Table 6 may be transmitted as a part of any existing frame/element/field/subfield in the standard or can be a part of newly defined ones. For example, the information items may be included in the Multi-link reconfiguration element. In some embodiments, the Multi-link reconfiguration element may be included in the handover request message.

In operation 2303, the AP 1630 may transmit a handover request to the MLD Upper MAC sublayer of the parallel stack 1631. When the AP MLD that hosts the parallel stack receives the handover request frame, it may change the STA's configuration from one set of link configuration of the parallel stack to another. With the link configuration change procedure, the STA 1640 can move from one AP MLD to another without having to disassociate and reassociate.

In some embodiments, the handover procedure may be performed by any of the STA affiliated with the non-AP MLD.

In some embodiments, one of the existing procedures can be (re)used to perform handover. For example, Multi-link reconfiguration can be used to add or remove APs.

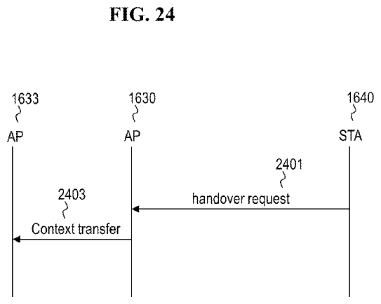

Hereinafter, the data continuity in accordance with various embodiments will be described with reference to FIG. 24.

FIG. 24 is a ladder diagram showing a context transfer procedure during a handover.

In operation 2401, the STA 1640 affiliated with the non-AP MLD may transmit a handover request frame and thereby the transition from a current AP 1630 to a new AP 1633 may occur. For convenience, the current AP may be referred to as a serving AP and the new AP may be referred to as a target AP.

When the transition occurs, there can be a context transfer from the serving AP 1630 to the target AP 1633. This may be done by transmitting a context transfer frame from the serving AP 1630 to the target AP 1633, in operation 2403. The context transfer frame may contain at least one or more of the information items as indicated in Table 7. Table 7 shows information items that may be included in the context transfer frame.

TABLE 7

| Information | |
|---|---|
| items | Description |
| Feature | An information item that can indicate the feature for which |
| indication | the context transfer is to occur. For example, this |
| | information item may indicate block ACK setup, EPCS |
| | setup, security, PN, SN, QoS, etc. as the features. |
| Transfer | An information item that can indicate the time at which the |
| time | context transfer can occur. For example, this information |
| | item may indicate the number of TBTTs from the current |
| | TBTT at which the transfer can occur, time duration, etc. |

The above information items can be transmitted together or separately. They can be transmitted as a part of any existing frame/element/field/subfield in the standard or can be a part of newly defined ones. For example, the information items may be included in a resource information container, newly defined element, etc.

In some embodiments, when the transition occurs, the serving AP 1630 may transfer the context to the target AP 1633. After the transfer time, the context at the serving AP 1630 can be removed as the STA 1640 starts to operate with the target AP 1633.

The serving AP 1630 can either complete its existing downlink (DL) transmissions before the handover or can transfer the DL frames buffered to the target AP 1633 if the transmissions cannot be completed before the transfer time. After the transfer time, the data path can switch over to the target AP 1633.

The STA 1640 that undergoes the handover can complete UL transmissions before the handover or can transfer the uplink (UL) frames buffered to the target AP 1633 if the transmissions cannot be completed before the transfer time. After the transfer time, the STA 1640 can delete information related to the serving AP 1630 and can start to interact with the target AP 1633.

In some embodiments, there can be more than one AID that can be assigned to support parallel stack operation.

During operation, when a non-AP MLD has formed links with more than one non-collocated APs which may be affiliated with the same parallel stack, an additional parameter can be used together with the AID to identify the non-AP MLD. For example, the additional parameter may be a collocated set ID, an MLD MAC address, etc. The collocated set ID can be an identifier for APs that are collocated and part of the parallel stack.

In some embodiments, BSS transition management related frames (e.g., BTM frames) can be reused for communication between the non-collocated AP MLDs (e.g., for the purpose of multi-link reconfiguration).

The embodiments presented in this disclosure for enterprise network can be applicable to non-enterprise network cases. The embodiments presented in this disclosure for non-enterprise networks can be applicable to enterprise network cases.

The embodiments presented in this disclosure can be used for other purposes than mobility management. For example, the embodiments presented in this disclosure can be used for the multi-AP interference management, relay operation, etc.

The embodiments in this disclosure can be applicable to both single link as well as multi-link operation.

The various illustrative blocks, units, modules, components, methods, operations, instructions, items, and algorithms may be implemented or performed with a processing circuitry.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the subject technology. The term “exemplary” is used to mean serving as an example or illustration. To the extent that the term “include,” “have,” “carry,” “contain,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The embodiments are provided solely as examples for understanding the invention. They are not intended and are not to be construed as limiting the scope of this invention in any manner. Although certain embodiments and examples have been provided, it will be apparent to those skilled in the art based on the disclosures herein that changes in the embodiments and examples shown may be made without departing from the scope of this invention.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. An access point (AP) device comprising:
a communication interface; and
a processor operably coupled to the communication interface, the processor configured to cause:
establishing a logical AP multi-link device (MLD) with which a plurality of APs including one or more APs affiliated with a first physical AP MLD and one or more APs affiliated with a second physical AP MLD are affiliated.

2. The AP device of claim 1, wherein the processor is configured to further cause:
transferring a functionality of the logical AP MLD to a target AP MLD in response to a handover of a non-AP station (STA) from a serving AP MLD to the target AP MLD.

3. The AP device of claim 1, further comprising:
a plurality of APs affiliated with the AP device,
wherein at least one AP is affiliated with the logical AP MLD.

4. The AP device of claim 3, wherein the processor is configured to further cause:
tearing down a functionality of the logical AP MLD in response to a handover of a non-AP station (STA) from a serving AP MLD to the target AP MLD.

5. The AP device of claim 3, wherein the processor is configured to further cause:
transmitting, by an AP affiliated with the logical AP MLD, a frame including information for discovering the logical AP MLD.

6. The AP device of claim 5, wherein the processor is configured to further cause:
receiving, by an AP affiliated with the logical AP MLD, from an STA affiliated with a non-AP MLD, a request frame requesting information for discovering the logical AP MLD,
wherein the frame including information for discovering the logical AP MLD is transmitted to the non-AP MLD in response to the request frame.

7. The AP device of claim 3, wherein the processor is configured to further cause:
transmitting, by an AP affiliated with the logical AP MLD, a beacon frame including information for the logical AP MLD.

8. The AP device of claim 7, wherein the processor is configured to further cause:
transmitting, by an AP affiliated with the logical AP MLD, a frame including a link identifier and an identifier of the logical AP MLD,
the identifier of the logical AP MLD coupled with the link identifier indicates a link of a plurality of links in the logical AP MLD.

9. The AP device of claim 3, wherein the processor is configured to further cause:
receiving, from a station (STA) affiliated with a non-AP MLD, by an AP affiliated with the logical AP MLD, an association request frame to request an association with the logical AP MLD, and
transmitting, by an AP affiliated with the logical AP MLD, an association response frame to the STA affiliated with the non-AP MLD in response to the association request frame.

10. The AP device of claim 9, wherein the association response frame includes an association identifier and an identifier of the AP device,
the identifier of the AP device coupled with the association identifier indicates a value assigned to the non-AP MLD by the logical AP MLD for association.

11. The AP device of claim 3, wherein the processor is configured to further cause:
receiving, by an AP affiliated with the logical AP MLD, from a station (STA) affiliated with a non-AP MLD, a handover request frame to request a handover from a serving AP MLD to a target AP MLD.

12. The AP device of claim 11, wherein the processor is configured to further cause:
transmitting a context transfer frame from a serving AP to the target AP,
wherein the context transfer frame includes at least one of:
a type of context to be transferred, or
a transfer time at which context transfer occurs.

13. A non-AP MLD comprising:
a plurality of non-AP stations (STAs) affiliated with the non-AP MLD; and
a processor operably coupled to the communication interface, the processor configured to cause:
associating with a logical AP MLD with which a plurality of APs including one or more APs affiliated with a first physical AP MLD and one or more APs affiliated with a second physical AP MLD are affiliated.

14. The non-AP MLD of claim 13, wherein the processor is configured to further cause:
receiving, by an STA affiliated with the non-AP MLD, a frame including information for discovering the logical AP MLD.

15. The non-AP MLD of claim 14, wherein the information for discovering the logical AP MLD includes at least one of:
an information item indicating whether the plurality of APs are able to be associated with the logical AP MLD,
an information item indicating one or more of the plurality of APs are able to establish the logical AP MLD,
an identifier of the logical AP MLD,
an information item indicating whether the logical AP MLD has been established,
identifiers of APs affiliated with the logical AP MLD,
identifiers of AP MLDs having APs affiliated with the logical AP MLD,
a duration for which the logical AP MLD is hosted,
information describing capabilities of the logical AP MLD,
information describing constraints of the logical AP MLD,
information describing configuration of the logical AP MLD, or
information describing traffic status of the logical AP MLD.

16. The non-AP MLD of claim 14, wherein the processor is configured to further cause:
transmitting, by an STA affiliated with the non-AP MLD, to an AP affiliated with the logical AP MLD, a request frame requesting information for discovering the logical AP MLD,
wherein the frame including information for discovering the logical AP MLD is received in response to the request frame.

17. The non-AP MLD of claim 13, wherein the processor is configured to further cause:
receiving, by an STA affiliated with the non-AP MLD, a beacon frame including information for the logical AP MLD.

18. The non-AP MLD of claim 13, wherein the processor is configured to further cause:
transmitting, by an STA affiliated with the non-AP MLD, to an AP affiliated with the logical AP MLD, an association request frame to request an association with the logical AP MLD, and
receiving, by an STA affiliated with the non-AP MLD, an association response frame to the non-AP MLD in response to the association request frame.

19. The non-AP MLD of claim 13, wherein the processor is configured to further cause:
transmitting, by an STA affiliated with the non-AP MLD, to an AP affiliated with the logical AP MLD, a handover request frame to request a handover from a serving AP MLD to a target AP MLD.

20. The non-AP MLD of claim 19, wherein the handover request frame comprises at least one of:
current link configuration indicating current links of the non-AP MLD,
new link configuration indicating desired links of the non-AP MLD,
information indicating links which need to be added to multi-link operation of the non-AP MLD,
information indicating links which need to be deleted from multi-link operation of the non-AP MLD, or
information indicating a time after which transition from the current link configuration to the new link configuration occurs.
